(19) United States
(12) Patent Application Publication
(10) Pub. No.: US 2015/0251544 A1
(43) Pub. Date: Sep. 10, 2015

(54) VEHICULAR POWER SUPPLY SYSTEM

(71) Applicant: DENSO CORPORATION, Kariya-city (JP)

(72) Inventor: Takayuki SUGIYAMA, Kariya-shi (JP)

(21) Appl. No.: 14/621,951

(22) Filed: Feb. 13, 2015

(30) Foreign Application Priority Data
Mar. 5, 2014 (JP) 2014-042881

(51) Int. Cl. B60L 11/18; H02J 7/00; B60L 1/00

(52) U.S. Cl. CPC B60L 11/18; B60L 1/00; H02J 7/007

(57) ABSTRACT

A vehicular power supply system mounted on a hybrid vehicle equipped with an engine, a starter motor, a motor generator, a main battery and an auxiliary battery. The engine and the motor generator supply a driving power to drive wheels of the hybrid vehicle. The main battery in the vehicular power supply system is connected to the starter motor. The auxiliary battery is connected to an interrupt section and electrical loads such as an automobile navigation system. The main battery supplies electric power to the drive motor. The interruption section is arranged between a first group and a second group. The main battery and the starter motor belong to the first group. The auxiliary battery and the electrical loads belong to the second group. The interruption section interrupts an electrical power transmission from the auxiliary battery to the starter motor when the starter motor initiates the operation of the engine.

### CROSS-REFERENCE TO RELATED APPLICATION

This application is related to and claims priority from Japanese Patent Application No. 2014-42881 filed on Mar. 5, 2014, the contents of which are hereby incorporated by reference.

### BACKGROUND OF THE INVENTION

1. Field of the Invention

The present invention relates generally to vehicular power supply systems to be mounted on motor vehicles such as a hybrid vehicle which uses two or more distinct power sources, for example, an internal combustion engine and a motor generator as a drive motor. The internal combustion engine is equipped with a starter motor or a self-starter. The internal combustion engine and the drive motor supply a driving power to drive wheels of the hybrid vehicle.

2. Description of the Related Art

There have been used vehicular power supply systems. For example, a patent document 1, Japanese patent laid open publication No. JP 2013-13196, discloses a vehicular power supply system having a conventional structure. This vehicular power supply system is equipped with a main battery and an auxiliary battery. The main battery supplies electric power to the drive motor of the motor vehicle. The auxiliary battery supplies electric power to various types of electrical loads. The vehicular power supply system is capable of preventing a voltage drop of the auxiliary battery. That is, the vehicular power supply system guarantees a correct power supply to the auxiliary battery without a voltage drop of the auxiliary battery.

The vehicular power supply system having the structure previously described further has a supplemental battery in addition to the main battery and the auxiliary battery. When an output voltage of the auxiliary battery decreases to a predetermined voltage or less, the supplemental battery starts to supply electric power to the auxiliary battery.

By the way, the vehicular power supply system having a conventional structure disclosed in the patent document 1 previously described does not consider any temporary voltage drop in the auxiliary battery when the auxiliary battery supplies its output voltage to the starter motor and the electronic loads, and a temporary voltage drop of the output voltage of the auxiliary battery occurs. For example, when one of the electrical loads is a safety device of the motor vehicle, there is a possible incorrect operation of the safety device caused by a temporary voltage drop of the voltage when the voltage is supplied to both the starter motor and the safety device simultaneously. Further, when one of the electrical loads is an automotive navigation system mounted to the motor vehicle, there is a possible restart operation of the automotive navigation system when the voltage drop of the voltage supplied to the electrical loads occurs. As a result, this causes an uncomfortable feeling to the driver of the motor vehicle. By the way, it is possible to switch to the supplemental battery from the auxiliary battery when a voltage drop of the output voltage of the auxiliary battery occurs.

As previously described, because the vehicular power supply system disclosed in the patent document 1 is equipped with the supplemental battery in addition to the main battery and the auxiliary battery, the conventional structure of the vehicular power supply system causes various drawbacks. For example, the conventional structure of the vehicular power supply system requires an additional mounting space in which the supplemental battery is arranged and a total weight of the motor vehicle increases because of mounting the supplemental battery in addition to the main battery and the auxiliary battery. Further, the vehicular power supply system having the conventional structure requires an additional replacement cost of the supplemental battery.

### SUMMARY

It is therefore desired to provide a vehicular power supply system capable of suppressing a voltage drop of a voltage of a battery to be supplied to one or more electrical loads when a starter motor initiates the operation of an internal combustion engine of a motor vehicle such as a hybrid vehicle without equipping the motor vehicle with any supplemental battery.

An exemplary embodiment provides a vehicular power supply system to be mounted to various vehicles such as a hybrid vehicle. The hybrid vehicle is equipped with an internal combustion engine and a drive motor such as a motor generator. The internal combustion engine has a starter motor. The internal combustion engine and the drive motor supply a driving power to drive wheels of the hybrid vehicle. The vehicular power supply system has a main battery connected to the starter motor, an auxiliary battery connected to electrical loads, and an interruption section. The main battery supplies electric power to the drive motor. The interruption section such as an inverter and a switch is arranged between a first group and a second group. The main battery and the starter motor belong to the first group. The auxiliary battery and the electrical loads belong to the second group. The interruption section interrupts an electrical power transmission from the auxiliary battery to the starter motor.

Because the starter motor requires a large electric power when the starter motor drives the internal combustion engine to start its operation, a temporary voltage drop of an output voltage of a battery occurs when the battery supplies electric power to the starter motor. Accordingly, when an auxiliary battery supplies electric power to electrical loads connected to the auxiliary battery in addition to the starter motor, a malfunction of the electrical loads occurs due to the temporary voltage drop of the output voltage of the auxiliary battery.

When the vehicular power supply system according to an exemplary embodiment having the structure previously described is mounted to a hybrid vehicle equipped with an internal combustion engine and a motor generator, the vehicular power supply system can interrupt the electric power transmission to the starter motor from the auxiliary battery connected to the electrical loads when the main battery supplies electric power to the starter motor. This makes it possible to prevent a temporary voltage drop in the auxiliary battery when the starter motor drives the internal combustion engine. It is therefore possible for the vehicular power supply system to allow the auxiliary battery to provide a stable voltage to the electrical loads such as an automobile navigation system without using any additional battery such as a supplemental battery in addition to the main battery and the auxiliary battery.

### BRIEF DESCRIPTION OF THE DRAWINGS

A preferred, non-limiting embodiment of the present invention will be described by way of example with reference to the accompanying drawings, in which:

FIG. 1 is a view showing an electrical block diagram of a vehicular power supply system according to a first exemplary embodiment of the present invention;

FIG. 2 is a view showing an electrical path in the vehicular power supply system shown in FIG. 1 through which a main battery 21 supplies electric power to a starter motor 24;

FIG. 3 is a view showing an electrical path through which a motor generator 12 supplies regenerative electrical power to the main battery 21 and the auxiliary battery 31 in order to charge the main battery 21 and the auxiliary battery 31; and

FIG. 4 is a view showing an electrical block diagram of a vehicular power supply system according to a second exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

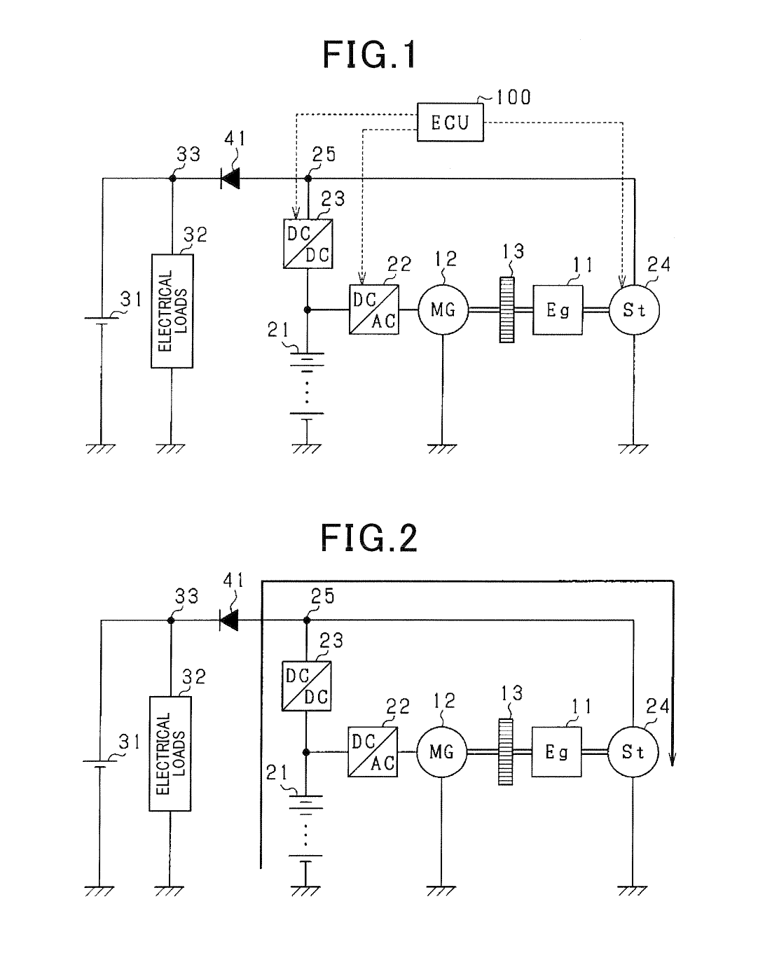

A description will be given of a vehicular power supply system according to a first exemplary embodiment with reference to FIG. 1 to FIG. 3.

FIG. 1 is a view showing an electrical block diagram of the vehicular power supply system according to the first exemplary embodiment. As shown in FIG. 1, the vehicular power supply system according to the first exemplary embodiment is mounted to a hybrid vehicle. In general, a hybrid vehicle is a vehicle that uses two or more distinct power sources to move the vehicle. For example, a hybrid electric vehicle (HEV) combines an internal combustion engine and one or more electric motors. In the first exemplary embodiment, the hybrid vehicle is equipped with an internal combustion engine 11 and a motor generator 12. The internal combustion engine 11 and the motor generator 12 generate and supply a driving power to a reduction gear unit 13 and the driving power drives the drive wheels of the hybrid vehicle connected to the reduction gear unit 13.

As shown in FIG. 1, the vehicular power supply system according to the first exemplary embodiment is equipped with the main battery 21, an inverter 22, a direct current to direct current converter (DC-DC converter) 23, a starter motor 24, an auxiliary battery 31, electrical loads 32, and a diode 41. The inverter 22 has a direct current input and output terminal and an alternating current input and output terminal. The DC-DC converter 23 has a first input and output terminal and a second input and output terminal. Further, the hybrid vehicle is equipped with an electrical control unit (ECU) 100. The ECU 100 generates and outputs various types of control signals to the inverter 22, the DC-DC converter 23 and the starter motor 24. When receiving the control signals transmitted from the ECU 100, each of the inverter 22, the DC-DC converter 23 and the starter motor 24 starts its operation.

A positive electrode terminal of the main battery 21 is connected to the direct current input and output terminal of the inverter 22 and the first input and output terminal of the DC-DC converter 23. The alternating current input and output terminal of the inverter 22 is connected to the motor generator 12. The second input and output terminal of the DC-DC converter 23 is connected to the starter motor 24 through a first connection node 25. On the other hand, the auxiliary battery 31 is connected to the electrical loads 32 through a second connection node 33.

In other words, as shown in FIG. 1, the first connection node 25 is connected to the second connection node 33 through the diode 41. An anode of the diode 41 is connected to the first connection node 25. A cathode of the diode 41 is connected to the second connection node 33. That is, a current flows from the first connection node 25 to the second connection node 33, but no current flows from the second connection node 33 to the first connection node 25 because the diode 41 interrupts a current flowing from the second connection node 33 to the first connection node 25. The actual operation of the diode 41 having general characteristics allows a small leakage current to flow from the second connection node 33 to the first connection node 25 through the diode 41.

The main battery 21 is a lithium ion rechargeable battery comprised of a plurality of battery cells connected in series. The main battery 21 outputs an output voltage within a range of 100 to 400 volts.

The inverter 22 receives a direct current power through the direct current input and output terminal, and converts the received direct current power to an alternating current power. The inverter 22 outputs the alternating current power to the motor generator 12 through the alternating current input and output terminal. Further, the inverter 22 receives an alternating current power supplied from the motor generator 12, converts the alternating current power to a direct current power, and outputs the direct current power through the direct current input and output terminal.

The motor generator 12 acts as a drive motor. When receiving the alternating current power outputted from the inverter 22, the motor generator 12 generates and outputs an output torque to the reduction gear unit 13. On the other hand, during a deceleration of the hybrid vehicle, the motor generator 12 acts as an electric power generator capable of performing a regeneration operation, i.e. generating an alternating current power. The DC-DC converter 23 receives a voltage through the first input and output terminal, and transforms the received voltage, and outputs the transformed voltage through the second input and output terminal. Further, the DC-DC converter 23 receives a voltage through the second input and output terminal, transforms the received voltage, and outputs the transformed voltage through the first input and output terminal.

When receiving a direct current power through the first connection node 25, the starter motor 24 initiates its rotation and gradually increases its rotation speed. Because the starter motor 24 is connected to a crankshaft of the internal combustion engine 11. The starter motor 24 thereby increases the rotation speed of the crankshaft of the internal combustion engine 11 to a predetermined rotation speed. This predetermined rotation speed allows the internal combustion engine 11 to initiate its operation.

The auxiliary battery 31 is a lead-acid rechargeable battery, for example. The auxiliary battery 31 outputs an output voltage of approximately 12 volts. The electric power outputted from the auxiliary battery 31 is supplied to the electrical loads 32 through the second connection node 33. For example, in-vehicle devices such as an automotive navigation system, and safety devices such as in-vehicle electronic control devices belong to the electrical loads 32.

FIG. 2 is a view showing an electrical path in the vehicular power supply system shown in FIG. 1 when the main battery 21 supplies electric power to the starter motor 24 in order to initiate the operation of the internal combustion engine 11. The DC-DC converter 23 transforms the voltage outputted from the main battery 21 to another voltage so that the transformed voltage becomes lower than the voltage outputted from the auxiliary battery 31. For this reason, the voltage at the first connection node 25 is lower than the voltage at the second connection node 33. This makes it possible to prevent the current flowing to the second connection node 33 from the first connection node 25. Accordingly, the electric power outputted from the main battery 21 and transformed by the DC-DC converter 23 can be supplied to the starter motor 24 without supplying the transformed voltage to the auxiliary battery 31 and the electrical loads 32

On the other hand, the diode 41 interrupts the current flow from the second connection node 33 to the first connection node 25. Accordingly, the electric power of the auxiliary battery 31 is supplied to the electrical loads 32 without to the starter motor 24.

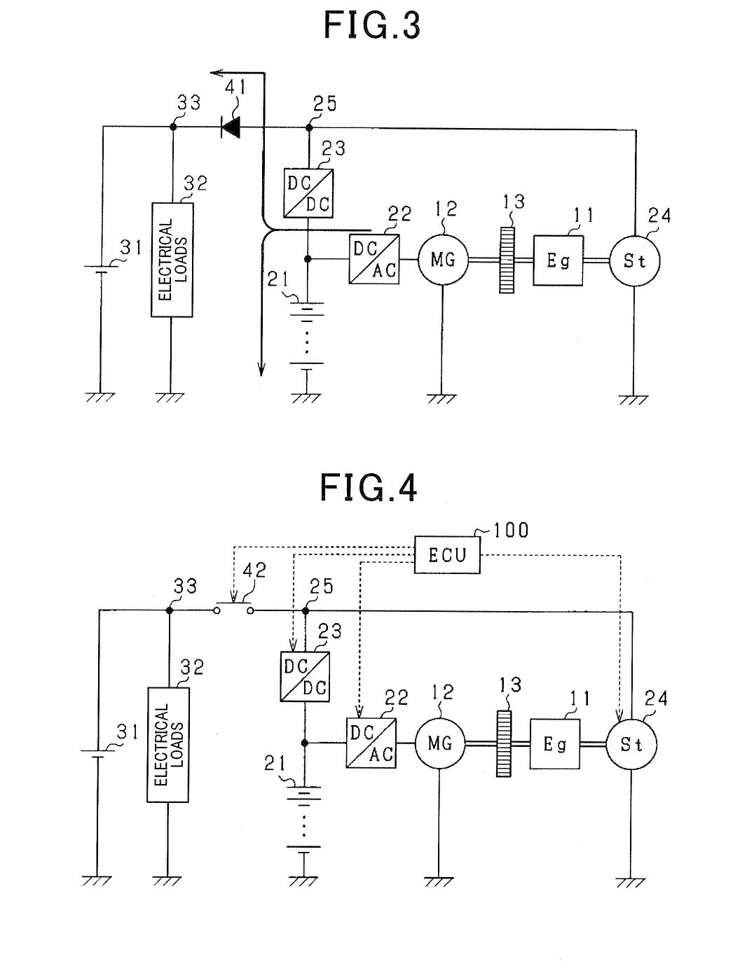

FIG. 3 is a view showing an electrical path through which the motor generator 12 supplies regenerative electric power to the main battery 21 and the auxiliary battery 31 in order to charge the main battery 21 and the auxiliary battery 31.

The motor generator 12 generates and outputs alternating current power. When receiving the alternating current power from the motor generator 12, the inverter 22 converts the received alternating current power to direct current power. The inverter 22 outputs the direct current power to the main battery 21 and the DC-DC converter 23.

The DC-DC converter 23 boosts the direct current voltage of the received direct current power to a predetermined voltage which is higher than the voltage of the auxiliary battery 31. Accordingly, the voltage at the first connection node 25 becomes higher than the voltage at the second connection node 33, and the current flows from the first connection node 25 to the second connection node 33. This current charges the auxiliary battery 31. That is, the main battery 21 and the auxiliary battery 31 are charged by the alternating current power outputted from the motor generator 12.

It is also possible for the DC-DC converter 23 to boost the voltage of the electric power outputted from the main battery 21 so that the boosted voltage becomes higher than the voltage of the auxiliary battery 31. In this case, the auxiliary battery 31 is charged by the boosted electric power outputted from the main battery 21.

By the way, there is a possible necessity of halting the electric power supply to the starter motor 24 when a short circuit failure occurs in the starter motor 24. In this case, the ECU 100 generates and transmits a control signal to the DC-DC converter 23 in order to halt the operation of the DC-DC converter 23. This control operation interrupts the electrical connection between the starter motor 24 and a group of the main battery 21 and the auxiliary battery 31. That is, this makes it possible to stop the electric power supply from the main battery 21 and the auxiliary battery 31 to the starter motor 24.

A description will now be given of the effects of the vehicular power supply system according to the first exemplary embodiment having the structure previously described.

Because the starter motor 24 requires a large amount of electric power when initiating the operation of the internal combustion engine 11, a temporary voltage drop occurs in a battery which supplies electric power to the starter motor 24. Accordingly, when the auxiliary battery 31 is connected to the electrical loads 32 in addition to the starter motor 24, and supplies electric power to the starter motor 24, a temporary voltage drop of the output voltage occurs in the auxiliary battery 31. As a result, a malfunction of the electrical loads 32 occurs by the temporary voltage drop of the output voltage of the auxiliary battery 31.

On the other hand, in the improved structure of the vehicular power supply system according to the first exemplary embodiment previously described, because the diode 41 interrupts the electric power supply from the second connection node 33 to the first connection node 25, it is possible to interrupt the electric power supply to the starter motor 24 from the auxiliary battery 31 connected to the electrical loads 32. This makes it possible to free the electrical loads 32 such as an automotive navigation system from the influence of the temporary voltage drop of the batter which supplies electric power to the starter motor 24. This structure allows the auxiliary battery 31 to supply a stable voltage to the electrical loads 32 and the main battery 21 to supply electric power to the starter motor 24 without using any additional battery.

In the improved structure of the vehicular power supply system according to the first exemplary embodiment previously described, the diode 24 interrupts the electric power supply from the auxiliary battery 31 to the starter motor 24. On the other hand, the ECU 100 outputs a control signal to the DC-DC converter 23 in order to interrupt the electric power supply from the main battery 21 to the starter motor 24. This makes it possible to interrupt a large current flowing to the starter motor 24 when malfunction of the starter motor 24 occurs without adding any specific safety device which prevents a large current from flowing into the starter motor 24 when a short-circuit failure occurs in the starter motor 24.

### Second Exemplary Embodiment

A description will be given of a vehicular power supply system according to a second exemplary embodiment.

FIG. 4 is a view showing an electrical block diagram of the vehicular power supply system according to the second exemplary embodiment. Similar to the vehicular power supply system according to the first exemplary embodiment previously described, the vehicular power supply system according to the second exemplary embodiment is mounted to a hybrid vehicle equipped with the internal combustion engine 11 and the motor generator 12.

In the vehicular power supply system according to the second exemplary embodiment, a switch 42 is used instead of the diode 41. The diode 41 is used in the vehicular power supply system according to the first exemplary embodiment previously described.

When receiving no control signal transmitted from the ECU 100 in the hybrid vehicle, the switch 42 connects the first connection node 25 to the second connection node 33. On the other hand, when receiving a control signal as an interrupt signal transmitted from the ECU 100, the switch 42 disconnects the first connection node 25 from the second connection node 33.

When receiving an engine start instruction signal to initiate the operation of the internal combustion engine 11, the ECU 100 continuously outputs an interrupt signal to the switch 42, and further continuously outputs a drive signal to the starter motor 24. The DC-DC converter 23 decreases the output voltage of the main battery 21 to a drive voltage of the starter motor 24, and supplies the decreased voltage to the starter motor 24. Because the switch 42 falls into the disconnection state, i.e. the interruption state, no electric power is supplied from the second connection node 33 to the first connection node 25 regardless of the output voltage of the DC-DC converter 23. That is, in the structure of the vehicular power supply system according to the second exemplary embodiment, it is possible for the main battery 21 to supply the electric power to the starter motor 24 through the electric path which is equal to the electrical path used in the structure of the vehicular power supply system according to the first exemplary embodiment previously described.

When the starter motor 24 initiates the rotation of the internal combustion engine 11, and the rotation speed of the internal combustion engine 11 reaches a rotation speed of not more than the predetermined rotation speed, the ECU 100 stops transmitting the drive signal to the starter motor 24, and stops transmitting the control signal as the interrupt signal to the switch 42. The switch 24 stops its operation and forms the electrical connection between the first connection node 33 and the second connection node 25.

When the switch 42 generates the electrical connection between the first connection node 33 and the second connection node 25, the vehicular power supply system according to the second exemplary embodiment supplies electric power to the auxiliary battery 31 from the motor generator 12 and the main battery 21, like the operation of the vehicular power supply system according to the first exemplary embodiment. Further, it is possible for the auxiliary battery 31 to supply electric power to the main battery 21 in order to charge the main battery 21 during the electrical connection state between the first connection node 33 and the second connection node 25 generated by the switch 24. In order to achieve this electrical charging operation to the main battery 21, it is sufficient to boost the voltage of the auxiliary battery 31, which is supplied to the DC-DC converter 23 through the second connection node 33 and the first connection node 25, to a voltage which is higher than the voltage of the main battery 21.

By the way, like the case caused in the vehicular power supply system according to the first exemplary embodiment, there is a possible necessity to temporarily halt the electric power supply to the starter motor 24 when the short-circuit failure occurs in the starter motor 24, for example. In this case, the ECU 100 generates and transmits the control signal to the DC-DC converter 23 and the switch 42 in order to stop the operation of the DC-DC converter 23, and interrupt the electrical connection between the first connection node 25 and the second connection node 33. This control operation makes it possible to interrupt the electrical connection between the starter motor 24 and the group composed of the main battery 21 and the auxiliary battery 31, and thereby to halt the electric power supply to the starter motor 24.

In the structure of the vehicular power supply system according to the second exemplary embodiment previously described, the switch 42 generates the electrical connection state between the first connection node 25 and the second connection node 33 during the period in which the switch 42 receives no control signal. However, the concept of the present invention is not limited by this structure. For example, it is possible for the switch 42 to generate the electrical connection state between the first connection node 25 and the second connection node 33 during a period in which the switch 42 receives the control signal transmitted from the ECU 100. That is, the ECU 100 continuously transmits the control signal to the switch 42, and stops transmitting the control signal to the switch 42 only when the ECU 100 receives the engine start instruction signal.

The vehicular power supply system according to the second exemplary embodiment has the following additional effects in addition to the effects of the vehicular power supply system according to the first exemplary embodiment previously described.

When the diode 41 is used as the interrupt device in the vehicular power supply system, there is a possible necessity for the DC-DC converter 23 to output a voltage which is lower than the output voltage of the auxiliary battery 31 in order to prevent a current from flowing the first connection node 25 to the second connection node 33 during the electric power supply of the main battery 21 to the starter motor 24. This structure generates a voltage limitation of the starter motor 24.

On the other hand, because the vehicular power supply system according to the second exemplary embodiment uses the switch 42 instead of the diode 41, it is possible to use an optional drive voltage of the starter motor 24 regardless of the voltage of the auxiliary battery 31.

### (Modifications)

The concept of the present invention is not limited by the structure of the vehicular power supply system according to the first exemplary embodiment and the second exemplary embodiment previously described.

The first exemplary embodiment and the second exemplary embodiment use a lithium ion rechargeable battery as the main battery 21, and a lead-acid rechargeable battery as the auxiliary battery 31. However, the concept of the present invention is not limited by this structure. It is possible to use other types of the battery instead of using the lithium ion rechargeable battery and the lead-acid rechargeable battery.

In the structure of the vehicular power supply system according to the first exemplary embodiment and the second exemplary embodiment, the main battery 21 has the voltage which is higher than the voltage of the auxiliary battery 31. However, the concept of the present invention is not limited by this structure. It is also possible to use the voltage of the main battery 21 which is lower than the voltage of the auxiliary battery 31. In this case, when the main battery 31 supplies electric power to the auxiliary battery 31, it is sufficient for the DC-DC converter 31 to boost the voltage of the main battery 21 so that the boosted voltage becomes higher than the voltage of the auxiliary battery 31.

Still further, in the structure of the vehicular power supply system according to the second exemplary embodiment, it is sufficient for the DC-DC converter 23 to decrease the voltage of the auxiliary battery 31 when the auxiliary battery 31 supplies electric power to the main battery 21.

In the structure of the vehicular power supply system according to the first exemplary embodiment and the second exemplary embodiment, the motor generator 12 supplies regenerative electric power to the main battery 21 and the auxiliary battery 31 in order to charge the main battery 21 and the auxiliary battery 31. However, the concept of the present invention is not limited by this structure. It is possible for the starter motor 24 to generate electric power and charges the main battery 21 and the auxiliary battery 31 by using the electric power generated by the starter motor 24 when the starter motor 24 has the function to generate electric power.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A vehicular power supply system to be mounted to a vehicle equipped with an internal combustion engine and a drive motor, the internal combustion engine having a starter motor, and the internal combustion engine and the drive motor supplying a driving power to drive wheels of the vehicle, the vehicular power supply system comprising:
a main battery connected to the starter motor and capable of supplying electric power to the drive motor;
an auxiliary battery connected to electrical loads; and
an interruption section arranged between a first group and a second group, the main battery and the starter motor belonging to the first group, and the auxiliary battery and the electrical loads belonging to the second group, and the interruption section being capable of interrupting an electrical power transmission from the auxiliary battery to the starter motor.

2. The vehicular power supply system according to claim 1, further comprising a direct current to direct current converter through which the main battery supplies electric power to the starter motor.

3. The vehicular power supply system according to claim 1, wherein the interruption section is a diode, and a cathode of the diode is connected to the auxiliary battery and the electrical loads, and an anode of the diode is connected to the main battery and the starter motor.

4. The vehicular power supply system according to claim 2, wherein the interruption section is a diode, and a cathode of the diode is connected to the auxiliary battery and the electrical loads, and an anode of the diode is connected to the main battery and the starter motor.

5. The vehicular power supply system according to claim 1, wherein the interruption section is a switch capable of switching to a connection state and an interruption state on the basis of a control signal transmitted from a control section in the vehicle, the connection state of the switch allows the auxiliary battery to supply electric power to the starter motor, and the interruption state of the switch interrupts the electric power transmission from the auxiliary battery to the starter motor.

6. The vehicular power supply system according to claim 2, wherein the interruption section is a switch capable of switching to a connection state and an interruption state on the basis of a control signal transmitted from a control section in the vehicle, the connection state of the switch allows the auxiliary battery to supply electric power to the starter motor, and the interruption state of the switch interrupts the electric power transmission from the auxiliary battery to the starter motor.

7. The vehicular power supply system according to claim 1, wherein the main battery is a lithium ion rechargeable battery and the auxiliary battery is a lead-acid rechargeable battery, and the main battery supplies an output voltage which is higher than an output voltage of the auxiliary battery.

8. The vehicular power supply system according to claim 5, further comprising a direct current to direct current converter arranged between the switch and the main battery, wherein when the switch makes the connection state, the direct current to direct current converter boosts an output voltage of the auxiliary battery to a voltage which is higher than the output voltage of the main battery and the main battery is changed by the boosted voltage.
